(19) United States
(12) Patent Application Publication
(10) Pub. No.: US 2005/0264842 A1
(43) Pub. Date: Dec. 1, 2005

(54) Computer-readable record medium recording a driver program and data transfer method

(75) Inventor: Tetsuya Suzuki, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/136,706

(22) Filed: May 25, 2005

(30) Foreign Application Priority Data
May 26, 2004 (JP) 2004-156513

(51) Int. Cl. H04N 1/64

(52) U.S. Cl. 358/1.15; 358/1.16; 358/524

(57) ABSTRACT

A driver program for generating image data and transferring this image data to the printing device is provided, and whereby efficient data transfer can be obtained. A driver program causes the host device to execute processing for generating image data and transferring the image data to the printing device whereby, when performing transfer of image data corresponding to one page, if the amount of the image data is smaller than a predetermined first amount, the image data is transferred by band sequential transfer; if the image data amount is equal to or more than the first amount but smaller than a predetermined second amount, the image data is transferred by plane sequential transfer; and if the image data amount is equal to or more than the second amount, band sequential transfer and plane sequential transfer are employed in mixed fashion for transfer.

### BACKGROUND OF THE INVENTION

1. Field of the Invention

The present invention relates to a computer-readable record medium recording a driver program or the like for causing the host device to execute processing for generating image data in a host device and transferring this image data to a printing device and in particular relates to a computer-readable record medium recording a driver program or the like capable of performing efficient transfer of the image data, taking into account both the amount of data to be accumulated in the host device and the timing of commencement of printing by the printing device.

2. Description of the Related Art

Usually, in a printing system in which printing is executed on a printing medium such as paper, printing data are transmitted from a host device such as a personal computer and the printing is executed in accordance with this printing data by the printing device that receives this printing data. Until printing is completed, processing such as processing to convert the data of the printing request that is issued from an application in the host device into image data represented by color density values for each pixel, and processing to convert the color representation of this image data into a color representation on the printing device and processing to convert the data after this color conversion into a dot image are performed on this printing data.

In such a printing system, in recent years, so-called host-based processing has come to be performed, in which the processing up to and including the processing for the above color conversion is performed by the host device. If this is done, the image data after color processing is transmitted to the printing device after compression by the host device and the printing device employs the data which it receives after decompression. Also, in the compression processing of image data that is transmitted from the host device, usually, processing is performed for each region, called a band, obtained by dividing a range corresponding to one page of the printing medium with a prescribed length in the height direction. For example, if the image data after the color conversion is expressed by Y (yellow), M (magenta), C (cyan), and K (black), image data including these four colors is subjected to sequential compression processing in band units to convert it to a condition capable of transmission to the printing device.

Such data transfer to a printing device after compression processing was conventionally performed by various methods. One of these methods was to perform transmission to the printing device sequentially from band image data in respect of which compression had been completed, in the order of the compression processing described above. Transmission of data in accordance with band sequence irrespective of the color of the image data in this way will hereinbelow be termed band sequential data transfer. In the case where the printing device is a device that performs printing processing, one color at time, in respect of a single page of the printing medium, such as for example a 4-cycle laser printer, the printing device must receive image data such that the image data of at least the first color arrives in time for the printing processing of this color. Usually, the printing processing i.e. the printing processing of the page cannot be commenced until substantially all of the image data of this first color has been received. In the method in which transmission to the printing device is effected sequentially from the image data (corresponding to all the colors) of a band whose compression has been completed, in accordance with the band sequence referred to above, reception of the image data of the first color in respect of the page that is being processed takes place with substantially the same timing as the timing of reception of all of the image data of the page by the printing device. Consequently, in this method of data transfer, printing processing in respect of the page that is to be processed cannot be commenced ahead of time.

Another method of data transfer is the method in which the compressed image data in each band is accumulated in the host device and data transfer to the printing device of the image data corresponding to one page is effected in the order in which printing processing of the colors is performed by the printing device. For example in the case where the image data is constituted by YMCK four-color data, first of all, all of the Y data, of the image data corresponding to one page, is transferred and then all of the M data, all of the C data and all of the K data are transferred in turn. This method, in which the image data corresponding to one page is thus transmitted in color sequence irrespective of the order of the bands, will hereinbelow be referred to as plane sequential data transfer. Such a method is adopted for example in the device described in Laid-open Japanese Patent Application No. 2002-236563. In the case of a printing device such as for example a 4-cycle laser printer in which printing processing is performed one color at a time for each page, if the method is adopted, as described above, in which data transfer of image data corresponding to one page to the printing device is performed in the order in which the printing processing of the colors is performed, it becomes possible to commence printing processing of the page at an early stage during this data transfer. This method, in which printing processing in respect of the page is commenced before all of the image data in respect of a single page have been received, will be termed the “flying start” method.

However, if the method of transmitting to the printing device sequentially after the image data (corresponding to all the colors) of a band whose compression has been completed, always in accordance with band sequence as described above, is adopted, as described above, in the case of a printing device that performs processing in page sequence, a flying start cannot be achieved at an early time-point, giving rise to the problem that throughput of the printing device cannot be improved.

Also, if the method is adopted in which data transfer to the printing device is performed in a sequence according to which printing processing of the colors is performed in respect of the image data corresponding to a single page, always in accordance with the plane sequence described above, although a flying start can be achieved at an early time-point, most of the image data corresponding to a single page must be temporarily accumulated in the host device, so the memory (RAM or the like) of the host device is employed for this purpose, giving rise to the possibility that the processing performance of the host device may be adversely effected.

### SUMMARY OF THE INVENTION

Accordingly, an object of the present invention is to provide a driver program or the like wherein the processing for generating image data at the host device and transferring this image data to the printing device is executed in the host device, and whereby efficient data transfer can be achieved in terms of achieving a balance of processing performance of the host device and throughput of the printing device.

In order to achieve the above object, according to one aspect of the present invention, a computer-readable record medium recording a driver program that causes the host device to execute processing for generating image data comprising data of a plurality of colors and transferring the image data to the printing device causes said host device to execute processing whereby, when performing transfer of said image data corresponding to one page to said printing device, if the amount of said image data corresponding to one page is smaller than a predetermined first amount, said image data corresponding to one page is transferred to said printing device by band sequential transfer in which data transfer is performed in accordance with the order of bands obtained by dividing said image data corresponding to one page at prescribed heights irrespective of color; if said image data amount corresponding to one page is equal to or more than said first amount but smaller than a predetermined second amount that is larger than said first amount, said image data corresponding to one page is transferred to said printing device by plane sequential transfer in which data transfer is performed in accordance with the order of colors, irrespective of said bands; and if said image data amount corresponding to one page is equal to or more than said second amount, said image data corresponding to one page is transferred to said printing device in mixed fashion using both said band sequential transfer and said plane sequential transfer. Consequently, according to the present invention, efficient data transfer can be performed taking into account both processing performance of the host device and throughput of the printing device, by selection of a suitable data transfer method depending on the size of the data of that is transmitted to the printing device.

Furthermore, in the invention described above, in a preferred embodiment, the transfer processing in which said band sequential transfer and plane sequential transfer are employed in mixed fashion comprises a first step wherein data of all or some of the colors of said plurality of colors is transferred to said printing device by said band sequential transfer and, if this transfer is performed in respect of said data of some of the colors, data of the colors that were not transferred is accumulated in said host device, and a second step in which the data accumulated in said first step is transferred to said printing device by said plane sequential transfer, wherein the number of colors whose data is transferred in said first step changes with a prescribed timing such that the volume of the data of each color that is accumulated in said host device is smaller for the color that is used earlier in said printing device. In this way, data transfer can be performed in an advantageous fashion, since the timing of a flying start when data transfer to the printing device is performed in which band sequential transfer and plane sequential transfer are employed in mixed fashion is advanced.

In order to achieve the above object, according to another aspect of the present invention, in a data transfer method whereby image data comprising data of a plurality of colors generated in an host device is transferred to a printing device, when performing transfer of said image data corresponding to one page to said printing device, if the amount of said image data corresponding to one page is smaller than a predetermined first amount, said image data corresponding to one page is transferred to said printing device by band sequential transfer in which data transfer is performed in accordance with the order of bands obtained by dividing said image data corresponding to one page at prescribed heights irrespective of color; if said image data amount corresponding to one page is equal to or more than said first amount but smaller than a predetermined second amount that is larger than said first amount, said image data corresponding to one page is transferred to said printing device by plane sequential transfer in which data transfer is performed in accordance with the order of colors, irrespective of said bands; and if said image data amount corresponding to one page is equal to or more than said second amount, said image data corresponding to one page is transferred to said printing device in mixed fashion using both said band sequential transfer and said plane sequential transfer.

Furthermore, in the invention described above, in a preferred embodiment, the transfer processing in which said band sequential transfer and plane sequential transfer are employed in mixed fashion comprises a first step wherein data of all or some of the colors of said plurality of colors is transferred to said printing device by said band sequential transfer and, if this transfer is performed in respect of said data of some of the colors, data of the colors that were not transferred is accumulated in said host device, and a second step in which the data accumulated in said first step is transferred to said printing device by said plane sequential transfer, wherein the number of colors whose data is transferred in said first step changes with a prescribed timing such that the volume of the data of each color that is accumulated in said host device is smaller for the color that is used earlier in said printing device.

Further objects and features of the present invention will become clear from the embodiments of the invention described below.

### BRIEF DESCRIPTION OF THE DRAWINGS

FIG. 1 is a layout diagram of an embodiment of the present invention.

FIG. 2 is a flow chart showing an example of the steps of data transfer processing;

FIG. 3 is a view showing diagrammatically image data corresponding to one page that is the subject of transfer;

FIG. 4 is a view showing an example of the steps in the case where band sequential transfer and plane sequential transfer are performed in mixed fashion;

FIG. 5 is a view given in explanation of an example in the case where band sequential transfer and plane sequential transfer are performed in mixed fashion; and

FIG. 6 is a time chart showing an example of data reception and transfer processing to the engine.

### DESCRIPTION OF THE PREFERRED EMBODIMENTS

An embodiment of the present invention is described below with reference to the drawings. However, this embodiment is not limitative of the technical scope of the present invention. Identical or similar items in the drawings are described by giving them the same reference numerals or reference symbols.

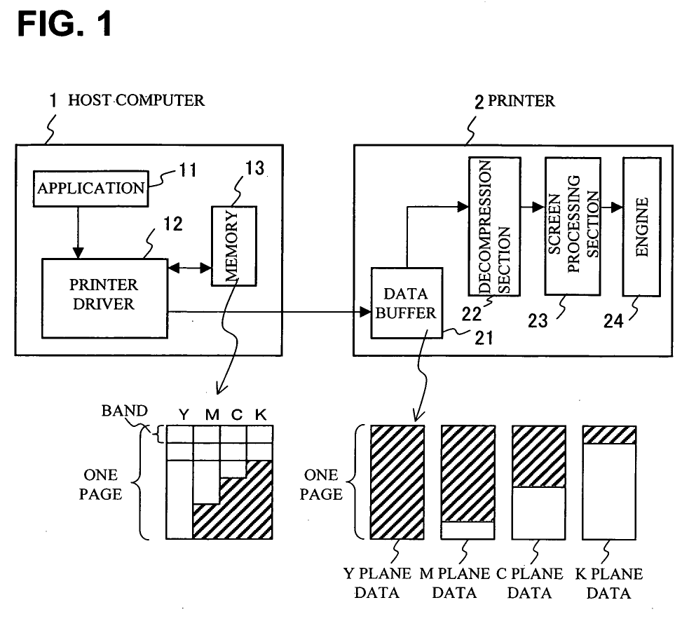

FIG. 1 is a layout diagram relating to an embodiment for implementing a printing system for employing a driver program according to the present invention. The printer driver 12 shown in FIG. 1 is a driver program using the present invention in a printing system comprising a host computer 1 and printer 2; the method of transfer of the image data after color conversion processing to the printer 2 is altered in accordance with the size of the image data in order to achieve efficient data transfer with a balance between processing performance of the host device and throughput of the printing device.

The host computer 1 is the host device in this embodiment and performs printing requests by transmitting image data, after color conversion processing, to the printer 2. As shown in FIG. 1, the host computer 1 comprises an application 11, printer driver 12 and memory 13. The host computer 1 may be constituted by a so-called personal computer or the like. The application 11 is the source of the printing request and may be for example text creation software and transfers the data to be printed to the printer driver 12 in a prescribed format.

The printer driver 12 is installed in and executed by the host computer 1. The printer driver 12 is read from a floppy disk or a CD-ROM and then installed in the host computer 1 or is downloaded from a server via the Internet or the like and then installed in the host computer 1.

The printer driver 12 is the section that receives a printing request from the application 11 and generates image data and transmits this image data to the printer 2. The printer driver 12 first of all interprets the data from the application 11 and expands it to the image data constituting the data to be printed for each pixel. This image data that is thus generated is data comprising density values of each color of for example R (red), G (Green), and B (blue). After this, the printer driver 12 performs color conversion processing in band units as described above on this RGB image data to convert it to the YMCK image data that is used by the printer 2. The printer driver 12 performs compression processing on this image data that is thus generated having data of each of the colors YMCK for each pixel, in band units. This is in order to shorten the data transfer time to the printer 2.

The image data that has thus been subjected to compression processing is in a condition in which it is capable of being transferred to the printer 2, the printer driver 12 performs data transfer processing on the image data after this compression processing has been completed. A characteristic feature of this printer driver 12 is in this data transfer method. A specific description will be given later, but separate use is made, as appropriate, in accordance with the data size of the page that is to be subjected to transfer processing, of a method in accordance with band sequence described above, a method in accordance with plane sequence or a method in which both of these are employed. The printer driver 12 may comprise a program that designates the procedure for processing as described above and a control device that executes the processing in accordance with this program.

Next, the memory 13 is RAM that is provided in the host computer 1 and is used in various applications. However, when executing printing, some of the image data that has been subjected to compression processing by the printer driver 12 is temporarily stored therein. The view that is shown below the memory 13 in FIG. 1 shows diagrammatically image data corresponding to one page after performance of compression processing. The image data corresponding to one page is constituted of data of a plurality of bands and, as described above, is constituted by YMCK data after color conversion. The details thereof will be described later, but, for example, the image data of the portion indicated by shading in the Figure is temporarily accumulated in this memory 13 during transfer of data corresponding to one page by the printer driver 12.

The printer 2 receives image data from the host computer 1 and executes printing in accordance with this image data and is a 4-cycle laser printer. As shown in FIG. 1, the printer 2 comprises a data buffer 21, decompression section 22, screen processing section 23, and engine 24. The data buffer 21 is the section that stores the image data that has been successively transferred from the printer driver 12. The view that is shown below the data buffer 21 in FIG. 1 is a view showing diagrammatically image data stored in the data buffer 21. As shown in this Figure, the data buffer 21 stores the image data corresponding to one page for each of the colors YMCK; these are called plane data. While the data corresponding to one page is being received, for example the image data of the portion indicated by the shading in the Figure is stored in this data buffer 21.

The printing processing from the processing in the decompressing section 22, to be described, to the point where printing is executed by the engine 24 is executed continuously, one color at a time, in page units, so the printer data for each color must all be received and stored in the data buffer 21 until processing of data transfer from the data buffer 21 for this color to the engine 24 has been completed. In other words, printing processing in respect of the page whose printing processing is to be performed can be commenced even in a condition in which the plane data for all the colors has not been received from the host computer 1. In other words, a flying start is possible. It should be noted that, in this embodiment, it is assumed that this printing processing is executed in YMCK order. For example, in the view below the data buffer 21 shown in FIG. 1, it will be assumed that the shaded sections indicate data that has already been stored in the data buffer 21. In the condition shown in the Figure, it may be said that this printing processing becomes possible in respect of the first color Y when the other conditions are satisfied. It is therefore not necessarily essential for this data buffer 21 to have a capacity sufficient to store at the same time all of the plane data of the four colors.

The decompression section 22 is a section that extracts the compressed data from the data buffer 21 when the printing processing is commenced and performs processing to restore this data to its original condition. Also, the screen processing section 23 is a section that executes screen processing on the data that have been decompressed by this decompression section 22 to convert the data of each pixel to dot image data. The engine 24 is a section that executes printing on to a printing medium in accordance with the data produced by the screen processing. In the printing processing that is performed by this decompression section 22, screen processing section 23 and engine 24, the various processes are performed synchronously, so that, as described above, they are executed continuously, one color at time, in page units.

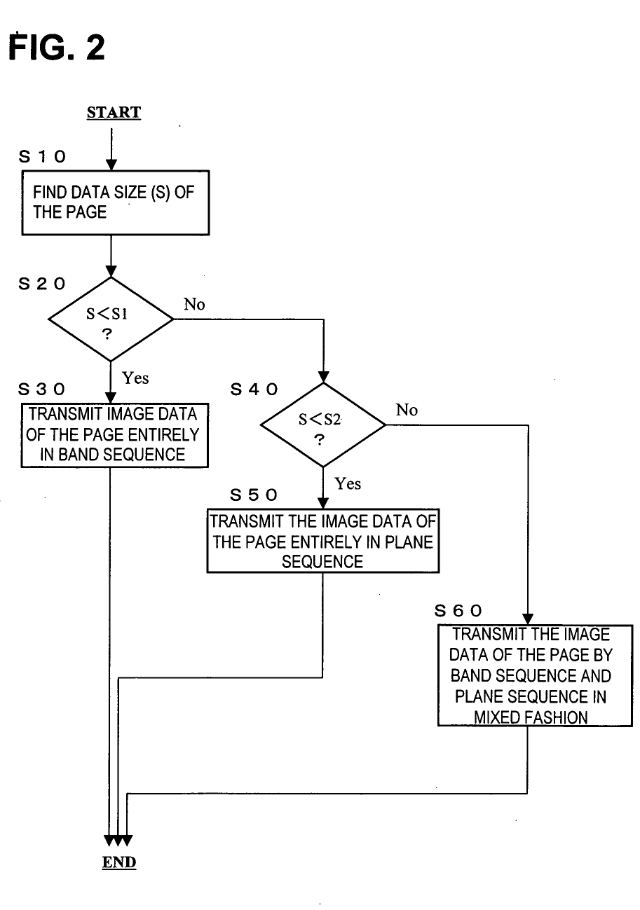

FIG. 2 is a flow chart showing by way of example the order of data transfer processing that is performed by the printer driver 12. Hereinbelow, the content of the data transfer processing that is a characteristic feature of this printer driver 12 will be described with reference to FIG. 2. It should be noted that the processing shown in FIG. 2 relates to data transfer corresponding to one page and is commenced prior to the time-point where the compression processing described above is commenced in respect of this page.

First of all the printer driver 12 finds (step S10) the data size (S) (image data amount) in respect of the page to be processed. The data size S that is thus found is preferably the size after this compression processing of this page, but, since, at this time-point, the compression processing in respect of this page will not have been completed, the exact size after compression cannot be found. Accordingly, the data size S is found by inference from for example the data size prior to compression processing. Also, it would be possible to assume a suitable data size S for the data size prior to compression processing.

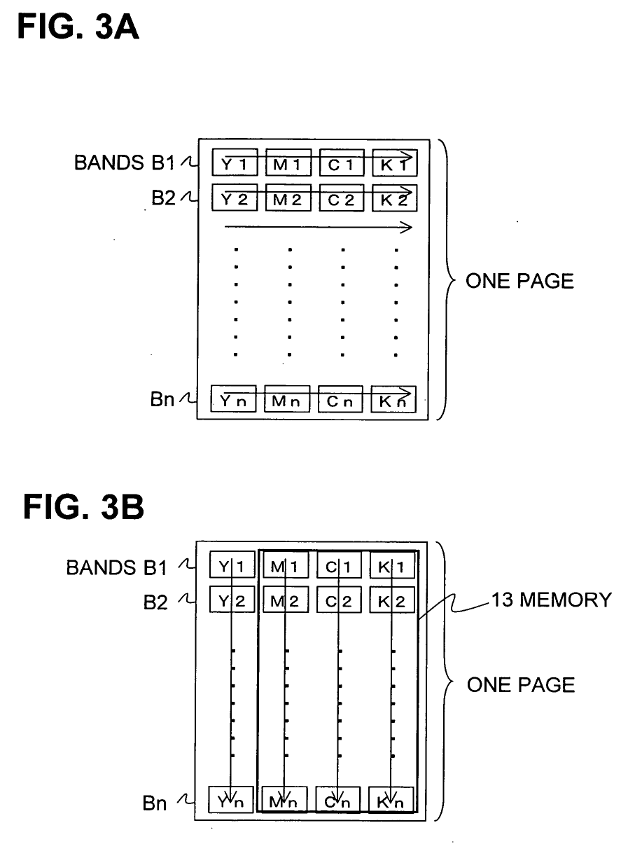

Next, the data size S that is thus found is compared with a predetermined first size S1 (first amount) (step S20) and, if S is smaller than this (Yes in step S20), the printer driver 12 transfers all of the image data corresponding to this page by the band sequential method described above (step S30). FIG. 3 is a view showing diagrammatically the image data corresponding to one page that is to be transferred. In the example shown in this Figure, one page is divided into n bands; these bands are called B1, B2, . . . , Bn in order from the top. The YMCK data contained in these bands will be denoted by Y1 to Yn, M1 to Mn, C1 to Cn and K1 to Kn. The data size S corresponding to one page referred to above means the size of all of the data indicated in FIG. 3A or 3B, for example.

FIG. 3A shows the transfer sequence in the case (step S30) in which data transfer is performed in accordance with the above band sequence. As described above, compression processing by the printer driver 12 is executed in band units in band sequence, then, with this method of transfer, the data of a band whose compression processing has been completed is directly transferred to the printer driver 2. Specifically, when the compression processing of the band B1 has been completed, the data of the processed Y1, M1, C1 and K1 is transmitted to the printer 2; after this, when the compression processing of the band B2 has been completed, the data of Y2, M2, C2 and K2 is transferred to the printer 2. Likewise in the same way, compression processing and transfer processing are repeated up to and including the band Bn. Thus, when data transfer is performed in band sequence as described above, sequential data are transferred from the top to the bottom in the direction of the arrow shown in FIG. 3A, and, since the compressed image data are directly transferred to the printer 2, there is no accumulation of compressed data on the host computer 1, so it is not necessary to secure storage space for this data on the memory 13.

Returning to FIG. 2, in step S20, if the data size S is larger than the first size S1 (No in step S20), the data size S is compared with the predetermined second size S2 (second amount) that is larger than the first size S1 (step S40). If then the size S is found to be smaller (Yes in step S40), the printer driver 12 transfers all of the image data of the page by plane sequential transfer as described above (step S50).

FIG. 3B shows the order of transfer in the case (step S50) where data transfer is performed in accordance with this plane sequence. The compression processing by the printer driver 12, as in the case described above, is performed in band units in band sequence, but, with this transfer method, the Y data, of the data of a band whose compression processing has been completed, is transmitted to the printer 2 and the remaining M, C, Y data is accumulated in the memory 13 without being transferred to the printer 2 at this time-point. Specifically, after completion of the compression processing of the band B1, Y1 is transferred to the printer 2 and M1, C1 and Y1 are stored in the memory 13. After this, when the compression processing of the band B2 has been completed, Y2 is transferred to the printer 2 and M2, C2 and K2 are accumulated. Compression processing and transfer and accumulation processing are repeated thereafter in the same way up to and including the band Bn. When compression processing is completed in respect of the page, the data accumulated in the memory 13 are transferred for each color in sequence from M to the printer 2. Specifically, first of all, M1 to Mn are transferred, then the data C1 to Cn, and K1 to Kn are transferred.

In this way, when data transference is performed in the plane sequence (step S50), data is successively transferred from left to right in the direction of the arrow shown in FIG. 3B and the sections (M1 to Mn, C1 to Cn and K1 to Kn) enclosed by the thick lines in Figure are accumulated in the memory 13.

Returning to FIG. 2, in the step S40, if the data size S is larger than the second size S2 (No in step S40), the printer driver 12 transfers image data corresponding to the page by a method in which the band sequential transfer and plane sequential transfer described above are performed in mixed fashion (step S60). A specific transfer method in this case is described below.

As described above, data transfer is performed by one or other method, depending on the data size S until transfer processing to the printer 2 in respect of the page has been completed. In this way, in the printer driver 12 according to this embodiment, if the data size of the page to be processed is small, transfer processing is performed in the band sequence; if the data size is intermediate, transfer processing is performed in accordance with the plane sequence; and if the data size is large, transfer processing is performed by the transfer sequence and plane sequence in mixed fashion. Hereinbelow, a specific method whereby such band sequence and plane sequence transfer may be performed in mixed fashion will be described.

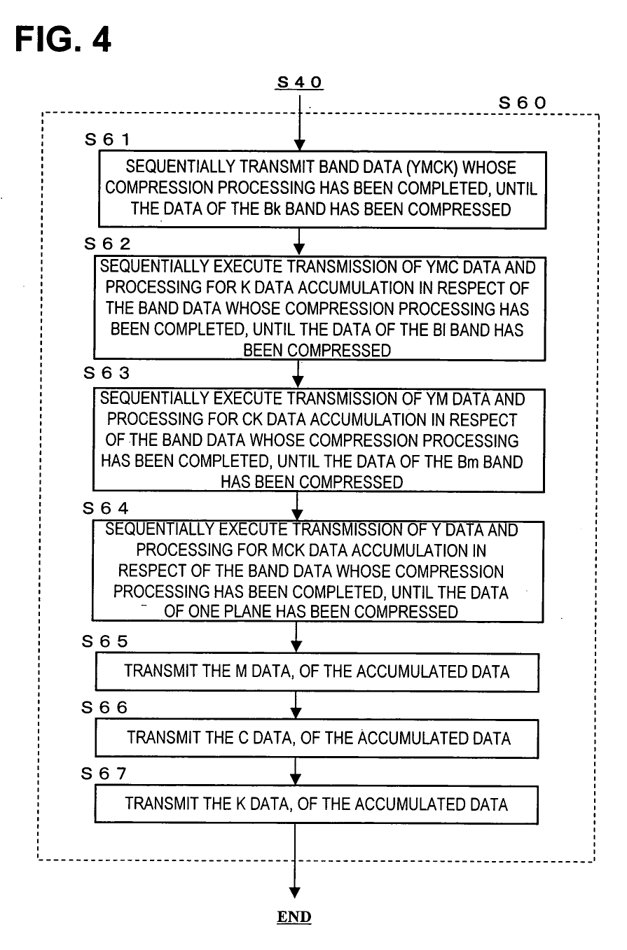

FIG. 4 is a flow chart showing an example of the procedure in the case where band sequence and plane sequence transfer are performed in mixed fashion (step S60). The printer driver 12 first of all performs data transfer (step S61) in band sequence up to a predetermined band (the k-th band). Specifically, in the same way as in the case of the step S30, up to the band Bk, band data after compression processing is not accumulated in the memory 13 and is thence directly transferred to the printer 2.

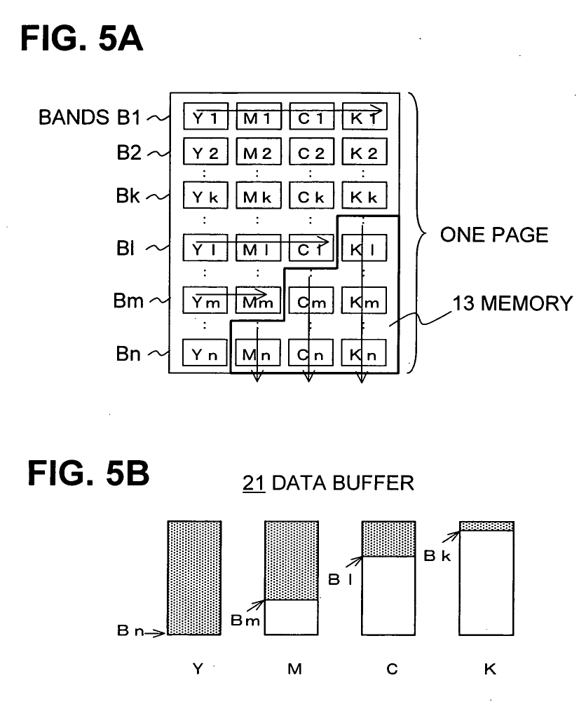

FIG. 5 is a view given in explanation of an example in the case where band sequence transfer and plane sequence transfer are performed in mixed fashion. FIG. 5A shows diagrammatically image data corresponding to one page that is to be transferred in the same way as FIG. 3; in this case also, one page is constituted of n bands. In this data transfer procedure (step S61) in band sequence, in the example shown in FIG. 5A, sequential data is transferred in the order: band B1, B2, . . . , Bk. In more detail, data transfer is performed in the order: Y1→M1→C1→K1→Y2→M2→C2→K2 in accordance with the direction of the arrow shown in band B1.

Next, when transfer of the band Bk has been completed, the printer driver 12 continues transfer in band sequence, but, up to and including the predetermined band (the l-th band), processing (step S62) is performed whereby, in respect of the data of a band that has been subjected to compression processing, the YMC data is transferred in band sequence but the remaining data i.e. the K data is accumulated in the memory 13. In the example shown in FIG. 5A, data transfer is performed in the order: Yk+1→Mk+1→Ck+1→Yk+2→ . . . Yl→Ml→Cl, in accordance with the direction of the arrow shown in band Bl but the data of Kk+1 to Kl is accumulated in the memory 13.

Next, when the transfer of band B1 has been completed, the printer driver 12 performs transfer in band sequence of the YM data of the bands that have been subjected to compression processing, and performs processing to accumulate the remaining data i.e. the CK data in the memory 13 up to and including a predetermined band (the m-th band) (step S63). In the example shown in FIG. 5A, data transfer is performed in the order: Yl+1→Ml+1→Yl+2→ . . . Ym→Mm in accordance with the direction of the arrow shown in the band Bm and the data of Cl+1 to Cm and Kl+1 to Km are accumulated in the memory 13.

Next, when transfer of the band Bm has been completed, the printer driver 12 performs transfer in band sequence, in respect of the data of the bands that have been compressed, only of the Y data, up to and including a predetermined band (the n-th band) i.e. in respect of the data corresponding to this one page whose compression processing has been terminated, and performs processing to accumulate the remaining, MCK data in the memory 13 (step S64). In the example shown in FIG. 5A, data transfer is performed in the order: Ym+1→Ym+2→ . . . . Yn and the data Mm+1 to Mn and Cm+1 to Cn and Km+1 to Kn are accumulated in the memory 13.

At the time-point where this processing of step S64 has been completed i.e. at the time-point where the compression processing in respect of the data corresponding to this one page has been completed all of the data in respect of Y will have been transferred, the data in respect of M will have been transferred up to and including the band Bm, the data in respect of C will have been transferred up to and including the band Bl and the data in respect of K will have been transferred up to and including the band Bk. FIG. 5B shows diagrammatically the plane data of the various colors stored in the data buffer 21 in the printer 2 at this time-point. The colored sections in the Figure show the stored data; data of each color up to and including the band in respect of which transfer has been performed are stored in the data buffer 21. Also, at this time-point, the data: Mm+1 to Mn and Cl+1 to Cn and Kk+1 to Kn will have been accumulated in the memory 13. In FIG. 5A, the data of the sections enclosed in the thick lines will have been stored in the memory 13.

In this way, when data transfer in band sequence has been completed from the step S61 to the step S64, the printer driver 12 transfers the data accumulated in the memory 13 to the printer 2 in plane sequence. First of all, all of the data in respect of M accumulated in the memory 13 are transferred (step S65). In the example shown in FIG. 5A, data transfer is performed in the order: Mm+1→Mm+2→ . . . →Mn in accordance with the direction of the downward arrow shown on the M data.

Next, all of the C data accumulated in the memory 13 are likewise transferred (step S66). In the example shown in FIG. 5A, data transfer is performed in the order: Cl+1→Cl+2→ . . . →Cn in the direction of the downwards arrow shown on the C data. Continuing in this way, all of the K data accumulated in the memory 13 are transferred (step S67). In the example shown in FIG. 5A, data transfer is effected in the order: Kk+1→Kk+2→ . . . →Kn, in the direction of the downwards arrow shown on the K data.

When the transfer of the data are accumulated in the memory 13 has been completed in this way, the data transfer processing in respect of the image data corresponding to this one page in the case where the band sequence and the plane sequence are employed in mixed fashion is terminated.

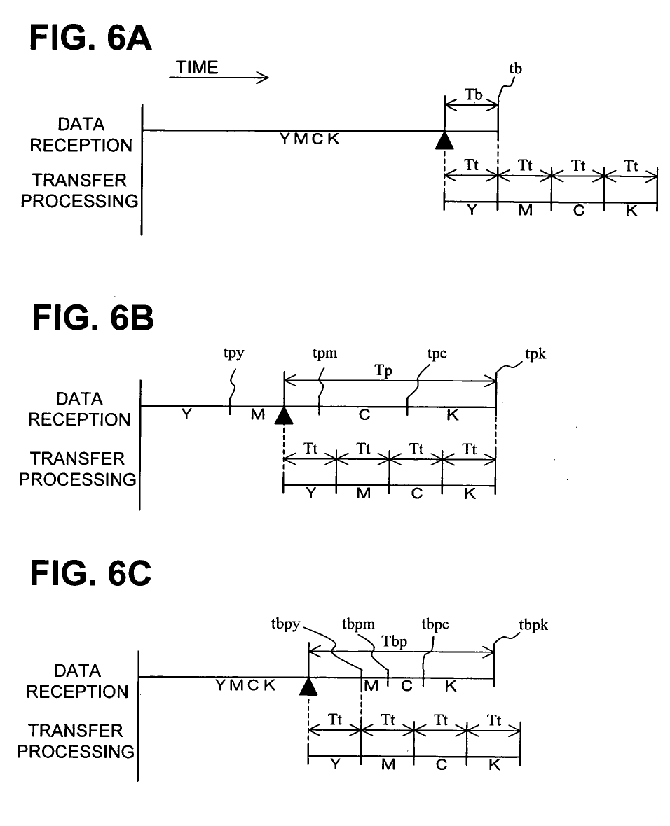

As described above, when image data corresponding to one page is transmitted, the printer driver 12 according to this embodiment transfers data to the printer 2 in a transfer order (method) in accordance with the data size S and appropriate to this size. FIG. 6 is time charts showing examples of the processing of reception of data by the printer 2 and transfer of the received data to the engine 24. FIGS. 6A and 6B respectively show typical timings for the case of transfer of all of the data corresponding to one page in band sequence and for the case of transfer of all of the data corresponding to one page in plane sequence when image data are transferred from the host computer 1 to the printer 2.

In FIG. 6A, the period from the left end of the line indicated as “data reception” up to the time-point represented by tb represents the time in which image data corresponding to one page is received. Also, the line indicated as “transfer processing” represents the time of the processing for transference of received image data stored in the data buffer 21 to the engine 24. As described above, when this transfer processing is commenced, the processing up to printing on the printing medium in the engine 24 is performed continuously with a synchronized timing and cannot be interrupted. Also, this transfer processing is performed in turn for each color and the time (Tt) required for each color is the same.

In the case of the band sequence shown in FIG. 6A, in respect of one page, data reception of each color is completed at the time-point tb at substantially the same time. Consequently, if transfer processing (printing processing) were to be commenced for the page earlier than a time-point (time-point indicated by a black triangle in the Figure) earlier than tb by the transfer processing time Tt corresponding to one color, a situation would be produced in which data reception would not be in time for the transfer processing of the first color, namely, Y and the aforementioned processing that should be performed continuously would in fact be interrupted. Accordingly, in the case of such a band sequence, the timing of the earliest flying start should be a time-point that is earlier than tb by an amount Tt. The “flying time” i.e. the time (Tb in the Figure) from the flying start until all of the data have been received must be smaller than Tt. Conversely, a flying start can be performed at a time-point where the time for receiving the remaining data during data reception is shorter than Tt.

In FIG. 6B also, the same representation is employed as in the case of FIG. 6A, but, since this is a case in which data transfer is performed in plane sequence, as shown in the Figure, sequential data reception is completed in the order: Y, M, C, K. tpy, tpm, tpc and tpk in the Figure respectively represent the timings of completion of data reception for each color. Also, the amount of data that is received for one page, the reception rate and the transfer time (Tt) for each color to the engine 24 are the same as in the case of FIG. 6A described above. Consequently, tpk, which is the timing of completion of data reception of K, i.e. the timing of completion of data reception corresponding to one page is the same as tb of FIG. 6A.

In the case of the plane sequence shown in this FIG. 6B, the order of data reception and the order of data transfer to the engine 24 are the same, so, normally, a flying start can be performed at a time-point at which the remaining data reception time during data reception is shorter than the time (Tt×4) taken for transfer processing of the page. In the example shown in FIG. 6B, the earliest timing of a flying start is the time-point indicated by the black triangle. In this case, for each color, reception of this color is completed by the time that transfer processing of this color is completed, so there is no possibility of interference with the transfer processing. Thus, in the case of this plane sequence, the “flying time” (Tp in the Figure) must be shorter than 4×Tt.

As described above, comparing the case in which transfer is performed solely in band sequence and the case where transfer is performed solely in plane sequence, Tp>Tb, so, in the case of transfer using plane sequence, the transfer processing (printing processing) can be commenced earlier.

As described above, in a printing system according to this embodiment, if the data size S corresponding to one page is smaller than the first size S1, data transfer is performed entirely using band sequence so that processing with the timing as shown in FIG. 6A is performed in the printer 2. That is, in this embodiment, the first size S1 is set as a small value such that the reception time (time from the left end up to tb in FIG. 6A) at the printer 2 is a time that is relatively considerably shorter in comparison with the transfer processing time (Tt in FIG. 6(a)) to the engine 24. Consequently, the difference of the timing at which a flying start can be performed with the case where transfer is effected entirely in plane sequence as described above—i.e. Tp−Tb in the example of FIG. 6—becomes considerably smaller compared with Tt. Consequently, in this case, the timing of the flying start need not be considerably delayed compared with the case of plane sequence and there is no need to accumulate the transferred data on the host computer 1.

Also, in this embodiment, as described above, if the data size S corresponding to one page is larger than the first size S1 but smaller than the second size S2, data transfer is performed entirely in plane sequence. This second size S2 is set to a size such that the size of the data (for example within the thick line in FIG. 3B) that must be accumulated on the memory 13 of the host computer 1 if all of the image data of one page corresponding to this size is transferred with plane sequence does not interfere much with the processing performance of the host computer 1. Also, in this case, in the printer 2, processing is performed with a timing as shown in FIG. 6B. Consequently, in this case, there is no need to accumulate data of a volume such as would cause interference with the processing performance of the host computer 1 in the memory 13, so a flying start can be performed with an early timing in the case where transfer is entirely effected in plane sequence.

Furthermore, in this embodiment, as described above, in the case where the data size S corresponding to one page is larger than the second size S2, data transfer is performed employing the band sequence and plane sequence in mixed fashion, as described with reference to FIG. 4 and FIG. 5. FIG. 6C shows an example of the processing timing in the printer 2 in the case where data transfer is performed in this way. In this example also, the amount of data that is received for one page, the reception rate and the transfer time (Tt) for each color to the engine 24 are the same as in the case of FIGS. 6A and 6B described above.

As described above, at the time-point where the Y data has all been transmitted to the printer 2, some of the data in respect of the other colors will have also been transmitted, so the timing of reception (tbpy in the Figure) of all of the Y data at the printer 2 will be later than the timing (tpy in the Figure) in the case where transfer is effected entirely in plane sequence. Also, usually, the times of completion of reception in respect of the M and C data also (tbpm and tbpc in the Figure) will be later than the timings for transfer performed entirely in plane sequence (tpm and tpc in Figure). Usually therefore in the case of this mixed-method transfer, it will not be possible to perform a flying start earlier than in the case where transfer is performed entirely in plane sequence. On the other hand, compared with the case where transfer is performed entirely in band sequence (for example the case of FIG. 6A), the timing of completion of reception of each color cannot be later than in the case where transfer is performed entirely in band sequence. Consequently, with this mixed transfer method, the timing of a flying start can be made earlier than in the case where transfer is performed entirely in band sequence.

From the above, for the flying timing in the case where such mixed-method transfer is performed, a timing can be adopted that is intermediate between the case of entirely plane sequential transfer and the case of entirely band sequential transfer. In the example shown in FIG. 6, for the time Tbp at which a flying start can be effected in the mixed-method case, a value between Tb and Tp may be taken. In the example of FIG. 6C, Y transfer processing cannot be completed before completion of Y reception, so the timing indicated by the black triangle in the Figure is the earliest flying start timing.

Also, the amount of data that must be accumulated in the memory 13 of the host computer 1 in the case of this mixed-method transfer can be relatively smaller than in the case where transfer is performed entirely in plane sequence (see FIG. 3B and FIG. 5A). Consequently, even if the entire data size of one page is larger than S2 referred to above, the amount of data that must be accumulated in the memory 13 can be suppressed to an extent such that it does not interfere with the processing performance of the host computer 1.

In the case where band sequential transfer and plane sequential transfer are employed in mixed fashion, some degree of benefit can therefore be obtained by performance of flying start, without interfering with the processing performance of the host computer 1. Usually, the timing with which a flying start can be formed is delayed if the amount of data that can be accumulated in the memory 13 is reduced and, conversely, the timing with which a flying start can be performed is advanced if the amount of data that can be accumulated in the memory 13 is made larger. Such adjustment can be made by altering the timings Bk, B1 and Bm described with reference to FIG. 4 and FIG. 5 with which the color of the data that is transferred to the printer 2 is changed over.

As described above, with a printer driver 12 according to this embodiment, when image data corresponding to one page is transmitted, data transmission to the printer 2 is performed by a method in accordance with each data size: if the data size is small, data transmission is performed entirely in band sequence, if the data size is intermediate, data transmission is performed entirely in plane sequence, and if the data size is large, data transmission is performed in accordance with band sequence and plane sequence in mixed fashion. Consequently, efficient data transfer can always be implemented taking into consideration both processing performance of the host computer 1 and throughput at the printer 2.

It should be noted that, in the case in which a transfer is effected in mixed fashion using both band sequence and plane sequence, in this embodiment, as shown by way of example in FIG. 5 A, accumulation of data in the memory 13 was performed in stepwise fashion such that data of a color that is early in the order of processing performed by the printer 2 is small in amount. However, this need not necessarily be the case. Also, the timing of changeover of data transfer to the printer 2 described above was determined in accordance with bands (Bk, B1 and Bm), but this timing could be arranged to be determined in accordance with data size or processing time.

The range of protection of the present invention is not restricted to the embodiment described above but extends to the inventions set out in the claims and equivalents thereof.

1. A computer-readable record medium recording a driver program that causes a host device to execute processing for generating image data comprising data of a plurality of colors and transferring said image data to a printing device, the driver program causing said host device to execute processing whereby, when performing transfer of said image data corresponding to one page to said printing device,
if the amount of said image data corresponding to one page is smaller than a predetermined first amount, said image data corresponding to one page is transferred to said printing device by band sequential transfer in which data transfer is performed in accordance with the order of bands obtained by dividing said image data corresponding to one page at prescribed heights irrespective of color;
if said image data amount corresponding to one page is equal to or more than said first amount but smaller than a predetermined second amount that is larger than said first amount, said image data corresponding to one page is transferred to said printing device by plane sequential transfer in which data transfer is performed in accordance with the order of colors, irrespective of said bands; and
if said image data amount corresponding to one page is equal to or more than said second amount, said image data corresponding to one page is transferred to said printing device in mixed fashion using both said band sequential transfer and said plane sequential transfer.

2. The record medium according to claim 1 wherein said transfer processing in which said band sequential transfer and plane sequential transfer are employed in mixed fashion comprises
a first step in which data of all or some of the colors of said plurality of colors is transferred to said printing device by said band sequential transfer and, if this transfer is performed in respect of said data of some of the colors, data of the colors that were not transferred is accumulated in said host device, and
a second step in which the data accumulated in said first step is transferred to said printing device by said plane sequential transfer, wherein
the number of colors whose data is transferred in said first step changes with a prescribed timing such that the volume of the data of each color that is accumulated in said host device is smaller for the color that is used earlier in said printing device.

3. A data transfer method for transferring image data comprising data of a plurality of colors generated in a host device to a printing device, wherein
when performing transfer of said image data corresponding to one page to said printing device,
if the amount of said image data corresponding to one page is smaller than a predetermined first amount, said image data corresponding to one page is transferred to said printing device by band sequential transfer in which data transfer is performed in accordance with the order of bands obtained by dividing said image data corresponding to one page at prescribed heights, irrespective of color;
if said image data amount corresponding to one page is equal to or more than said first amount but smaller than a predetermined second amount that is larger than said first amount, said image data corresponding to one page is transferred to said printing device by plane sequential transfer in which data transfer is performed in accordance with the order of colors, irrespective of said bands; and
if said image data amount corresponding to one page is equal to or more than said second amount, said image data corresponding to one page is transferred to said printing device in mixed fashion using both said band sequential transfer and said plane sequential transfer.

4. The data transfer method according to claim 3, wherein
said transfer processing in which said band sequential transfer and plane sequential transfer are employed in mixed fashion comprises
a first step in which data of all or some of the colors of said plurality of colors is transferred to said printing device by said band sequential transfer and, if this transfer is performed in respect of said data of some of the colors, data of the colors that were not transferred is accumulated in said host device, and
a second step in which the data accumulated in said first step is transferred to said printing device by said plane sequential transfer, wherein
the number of colors whose data is transferred in said first step changes with a prescribed timing such that the volume of the data of each color that is accumulated in said host device is smaller for the color that is used earlier in said printing device.

5. A data transfer method for transferring image data comprising data of a plurality of colors generated in a host device to a printing device, wherein
when performing transfer of said image data corresponding to one page to said printing device,
band sequential transfer, in which data transfer is performed in accordance with the order of bands obtained by dividing said image data corresponding to one page at prescribed heights, and plane sequential transfer in which data transfer is performed in accordance with the order of colors, are employed in mixed fashion for transfer of said image data corresponding to some bands to said printing device.

6. A computer-readable record medium recording a driver program that causes a host device to execute processing for generating image data comprising data of a plurality of colors and transferring said image data to a printing device, the driver program causing said host device to execute processing whereby, when performing transfer of said image data corresponding to one page to said printing device,
band sequential transfer and plane sequential transfer are employed in mixed fashion.
